(19) United States
(12) Patent Application Publication
(10) Pub. No.: US 2010/0211451 A1
(43) Pub. Date: Aug. 19, 2010

(54) INFORMATION PROCESSING APPARATUS, METHOD, AND STORAGE MEDIUM FOR STORING COMPUTER PROGRAM

(76) Inventor: Katsuhito Aoki, Tokyo (JP)

Correspondence Address: KENEALY VAIDYA LLP, 515 EAST BRADDOCK RD SUITE B, Alexandria, VA, 22314, US

(21) Appl. No.: 12/300,704

(22) PCT Filed: Jun. 27, 2008
(86) PCT No.: PCT/JP2008/061739

§ 371 Date: Nov. 13, 2008

(30) Foreign Application Priority Data
Nov. 8, 2007 (JP) 2007-291176

(51) Int. Cl. G06Q 30/00; G06Q 99/00; G06K 19/067

(52) U.S. Cl. 705/14.31; 235/380

(57) ABSTRACT

A system is provided to objectively represent in numerical form a reduction in the CO₂ emission by a consumer in an objective manner, whereby a CO₂ emission transaction can be performed with a company. Eco bag identification information read by a POS register terminal is received, consumer identification information correlated with the received eco bag identification information is searched and specified, points having a value that corresponds to a CO₂ emission quantity commensurate with a number of plastic shopping bags not used due to use of an eco bag are generated, a free gift selection request from the consumer is received, an instruction is issued to a company to provide the free gift to the consumer, the points used for free gift exchange are converted to a CO₂ emission quantity, and the CO₂ emission quantity is correlated with and granted to the company that provided the free gift.

### TECHNICAL FIELD

The present invention provides a system whereby a consumer can acquire a personal CO₂ emission credit according to a reduction in the number of plastic shopping bags used by the consumer, and perform a transfer of the emission credit.

### BACKGROUND ART

Due to recent increased environmental consciousness among consumers, there is a widespread practice of consumers bringing their own bags to supermarkets and convenience stores in order to reduce the use of so-called plastic shopping bags.

A consumer brings a personal shopping bag so as not to receive a so-called plastic shopping bag out of concern for the environment.

In such a case, a system exists in which a card is stamped at the supermarket or convenience store at each shopping visit, and a free gift or discount can be obtained when the stamps accumulate to ten stamps or another predetermined number.

Such initiatives have been implemented not only by individual stores, but at the municipality level as well. Shopping is being promoted using bonus stickers and the like by local governments as well.

In order to induce users to bring personal shopping bags and reduce the amount of plastic shopping bags used, and to lead customers to participating stores, an arrangement has been proposed as a system for reducing the use of supermarket and other plastic shopping bags, in which a barcode assigned in accordance with a shopping bag acquired by a user is read by a barcode reader; identification information indicated by the barcode and shopping information relating to shopping performed by the user are transmitted from a register terminal via a network; customer information that includes information relating to the user who acquired the shopping bag, acquired points accumulated by bringing the shopping bag and shopping, and information indicating a history of shopping performed by the user within a predetermined time period is stored in advance in correlation with identification information; the identification information and shopping information are received from the register terminal; the customer information is retrieved based on the identification information; points are added to the acquired points on the basis of the shopping information; and the shopping history information is updated (see Patent Document 1, for example).

[Patent Document 1]: Japanese Laid-open Patent Publication No. 2004-157634

### DISCLOSURE OF THE INVENTION

### Problems the Invention is Intended to Solve

However, the conventional technique in which a point is counted for each single shopping visit has drawbacks in that the consumer can only receive a fixed discount or service, and the merit to the consumer is extremely limited.

When the consumer prepares his own eco bag, the eco bag must be purchased, and a large burden is placed on the consumer, which is one reason for the use of eco bags not becoming widespread.

Drawbacks also occur when the program is implemented by a supermarket or convenience store, in that a large burden is placed on the supermarket or the like to provide discounts.

A supermarket or convenience store may also rent the eco bags in order to alleviate the burden on the consumer of purchasing an eco bag, but renting the eco bags also has drawbacks in that the consumer may discard the rented eco bag without returning the bag at the next shopping visit, or the eco bag may be roughly handled.

On the other hand, CO₂ emission credits are currently being traded on a global scale, and companies in various countries are participating in projects to reduce CO₂ emissions, but in order for a company to reduce CO₂, the company must take such measures as reviewing the company's own factories and product production lines, and large costs are involved.

Therefore, CO₂ emission quantities are being purchased from foreign companies.

However, regardless of the fact that the entity naturally most capable of reducing CO₂ is the consumer who consumes plastic shopping bags, products manufactured by companies, and the like, there is no technological device for objectively measuring the amount of CO₂ reduced by an individual person, and CO₂ emission credits therefore cannot be traded on an individual consumer level.

The present invention was developed in order to overcome the problems and issues described above, and an object of the present invention is to provide a system for objectively representing in numerical form a reduction in the CO₂ emission by a consumer in an objective manner, whereby a CO₂ emission transaction can be performed with a company.

### Means for Solving the Problems

The information processing apparatus according to an aspect of the present invention is an apparatus configured so as to be capable of communicating with a consumer terminal used by a consumer, a company terminal used by a company, and a POS register terminal for reading size information capable of specifying a size of an eco bag and identification information of an eco bag possessed by the consumer when the consumer purchases a product, in order for the consumer to perform a transaction based on a personal CO₂ emission quantity, by converting to a CO₂ emission quantity a reduction number by which the used number of plastic shopping bags that are newly distributed each time the consumer purchases a product at a store is reduced by the use of an eco bag capable of being repeatedly used by the consumer when a product is purchased; the information processing apparatus characterized in comprising a consumer information storage device for storing consumer identification information for identifying the consumer in correlation with eco bag identification information that identifies the eco bag possessed by the consumer; an emission credit storage device for storing, in correlation with the consumer identification information, points having a value corresponding to the CO₂ emission quantity and being acquired by the consumer through the use of the eco bag; a company information storage device for storing, in correlation with the CO₂ emission quantity acquired by the company, company identification information for identifying a company that desires to acquire a CO₂ emission quantity; a free gift information storage device for storing, in correlation with the company identification information, free gift information provided to the consumer by the company; a base points storage device for storing, in correlation with size information of the eco bag, a point number having a value that corresponds to a CO₂ emission quantity commensurate with a number of plastic shopping bags not used due to using the eco bag; a receiving device for receiving the size information and eco bag identification information read by the POS register terminal; a points processing device for referencing the consumer identification information device, searching and specifying the consumer identification information correlated with the received eco bag identification information, referencing the base points storage device to generate points on the basis of a point number correlated with the received size information, and storing the generated points in the emission credit storage device in correlation with the consumer identification information; and a free gift processing device for receiving, according to a request from the consumer terminal, a selection request of a free gift stored in the free gift information storage device in accordance with the point number acquired by the consumer that is stored in the emission credit storage device, issuing an instruction to the company terminal to provide the free gift to the consumer in accordance with the received free gift selection request, and storing the points used in the free gift exchange as a CO₂ emission quantity in the company information storage device in correlation with the company that provided the free gift.

The receiving device may furthermore receive size information of the eco bag, and the points processing device may be configured so as to generate points in accordance with the size information of the eco bag.

A configuration may be adopted in which an IC tag having the eco bag identification information is attached to the eco bag, and an RFID reader connected to the POS register terminal reads the eco bag identification information of the IC tag, whereby the receiving device acquires the eco bag identification information.

A configuration may be adopted in which the free gift information storage device stores negotiation condition information, which is a discount rate of points exchanged for a free gift of another competing company that is set by the company that provides free gifts; and when the consumer specifies application of a negotiation condition, the free gift processing device discounts the points necessary for point exchange of the free gift with the consumer and notifies the consumer terminal on the basis of the negotiation condition information stored by the free gift information storage device.

A configuration may also be adopted in which the negotiation condition information furthermore includes information of a company to be negotiated with; the free gift processing device references the free gift information storage device according to a request by the consumer, extracts and displays a plurality of companies providing the free gift, and determines whether the company to be negotiated with exists when the consumer specifies provision of a negotiation condition; and when the company to be negotiated with exists, the free gift processing device discounts the points necessary for point exchange of the free gift provided by the company for which the negotiation condition with the consumer was set and notifies the consumer terminal.

A configuration may be adopted in which a CO₂ reduction quantity acquired by the consumer through the use of the eco bag is furthermore stored in the emission credit storage device; the company information device (*1) furthermore stores a CO₂ reduction quantity that is a goal of the company; the consumer information storage device furthermore stores preference information that includes information of a free gift desired by the consumer; the consumer information storage device is referenced and a search is conducted for a consumer for whom a free gift provided by the company is registered as the preference information; and the points storage device is referenced, users among consumers for whom a free gift provided by the company is registered as the preference information are sorted in order of the largest acquired CO₂ reduction quantity with reference to the emission credit storage device, the CO₂ reduction quantities are totaled and computed in sequence until the total CO₂ reduction quantity reaches the CO₂ reduction quantity that is the goal of the company, and offer information of free gift exchange is transmitted to the consumer terminal in which the consumer for whom the CO₂ reduction quantities were totaled is a consumer who is the subject of an offer made by the company for free gift exchange.

A configuration may be adopted in which the points processing device generates, as tentative points, points having a value that corresponds to a CO₂ emission quantity commensurate with a number of plastic shopping bags not used due to the consumer using the eco bag, and converts the tentative points stored in the emission credit storage device into formal points that can be exchanged for a free gift when a transmission is received indicating a next time that the consumer uses the eco bag; and the emission credit storage device furthermore stores the generated tentative points in correlation with the consumer identification information.

A configuration may be adopted in which the points processing device computes a time elapsed until the next time the consumer uses the eco bag after the tentative points generation, and varies a conversion rate for converting to the formal points according to a length of the computed elapsed time.

A configuration may be adopted in which it is possible to connect to a recovery box apparatus for recovering the eco bag and acquiring recovered eco bag identification information, and in which the points processing device converts the tentative points stored in the emission credit storage device into formal points that can be exchanged for a free gift when an eco bag recovery notification is received from the recovery box apparatus.

A configuration may be adopted in which the points processing device computes a time elapsed from a day the eco bag was first used from the register terminal to a time of recovery by the recovery box apparatus, and varies the conversion rate for converting the tentative points into formal points according to the computed elapsed time.

The information processing method according to an aspect of the present invention is a method executed by a computer configured so as to be capable of communicating with a consumer terminal used by a consumer, a company terminal used by a company, and a POS register terminal for reading size information capable of specifying a size of an eco bag and identification information of an eco bag possessed by the consumer when the consumer purchases a product, in order for the consumer to perform a transaction based on a personal CO₂ emission quantity, by converting to a CO₂ emission quantity a reduction number by which the used number of plastic shopping bags that are newly distributed each time the consumer purchases a product at a store is reduced by the use of an eco bag capable of being repeatedly used by the consumer when a product is purchased; the information processing method characterized in the computer having: a consumer information storage device for storing consumer identification information for identifying the consumer in correlation with eco bag identification information that identifies the eco bag possessed by the consumer; an emission credit storage device for storing, in correlation with the consumer identification information, points having a value corresponding to the CO₂ emission quantity and being acquired by the consumer through the use of the eco bag; a company information storage device for storing, in correlation with the CO₂ emission quantity acquired by the company, company identification information for identifying a company that desires to acquire a CO₂ emission quantity; a free gift information storage device for storing, in correlation with the company identification information, free gift information provided to the consumer by the company; and a base points storage device for storing, in correlation with size information of the eco bag, a point number having a value that corresponds to a CO₂ emission quantity commensurate with a number of plastic shopping bags not used due to using the eco bag; and the computer executing the steps of: receiving the size information and eco bag identification information read by the POS register terminal; referencing the consumer identification information device, searching and specifying the consumer identification information correlated with the received eco bag identification information, referencing the base points storage device to generate points on the basis of a point number correlated with the received size information, and storing the generated points in the emission credit storage device in correlation with the consumer identification information; and receiving, according to a request from the consumer terminal, a selection request of a free gift stored in the free gift information storage device in accordance with the point number acquired by the consumer that is stored in the emission credit storage device, issuing an instruction to the company terminal to provide the free gift to the consumer in accordance with the received free gift selection request, and storing the points used in the free gift exchange as a CO₂ emission quantity in the company information storage device in correlation with the company that provided the free gift.

The storage medium in which a computer program is stored according to an aspect of the present invention causes processing to be executed in a computer that is configured so as to be capable of communicating with a consumer terminal used by a consumer, a company terminal used by a company, and a POS register terminal for reading size information capable of specifying a size of an eco bag and identification information of an eco bag possessed by the consumer when the consumer purchases a product, in order for the consumer to perform a transaction based on a personal CO₂ emission quantity, by converting to a CO₂ emission quantity a reduction number by which the used number of plastic shopping bags that are newly distributed each time the consumer purchases a product at a store is reduced by the use of an eco bag capable of being repeatedly used by the consumer when a product is purchased, the computer having: a consumer information storage device for storing consumer identification information for identifying the consumer in correlation with eco bag identification information that identifies the eco bag possessed by the consumer; an emission credit storage device for storing, in correlation with the consumer identification information, points having a value corresponding to the CO₂ emission quantity and being acquired by the consumer through the use of the eco bag; a company information storage device for storing, in correlation with the CO₂ emission quantity acquired by the company, company identification information for identifying a company that desires to acquire a CO₂ emission quantity; a free gift information storage device for storing, in correlation with the company identification information, free gift information provided to the consumer by the company; and a base points storage device for storing, in correlation with size information of the eco bag, a point number having a value that corresponds to a CO₂ emission quantity commensurate with a number of plastic shopping bags not used due to using the eco bag; and the storage medium in which a computer program is stored causes the computer to execute the steps of: receiving the size information and eco bag identification information read by the POS register terminal; referencing the consumer identification information device, searching and specifying the consumer identification information correlated with the received eco bag identification information, referencing the base points storage device to generate points on the basis of a point number correlated with the received size information, and storing the generated points in the emission credit storage device in correlation with the consumer identification information; and receiving, according to a request from the consumer terminal, a selection request of a free gift stored in the free gift information storage device in accordance with the point number acquired by the consumer that is stored in the emission credit storage device, issuing an instruction to the company terminal to provide the free gift to the consumer in accordance with the received free gift selection request, and storing the points used in the free gift exchange as a CO₂ emission quantity in the company information storage device in correlation with the company that provided the free gift.

### EFFECTS OF THE INVENTION

The present invention makes it possible to define a quantity of plastic shopping bags reduced through the use of an eco bag by a consumer, and to perform a CO₂ emission credit transaction in accordance with a reduction in the number of plastic shopping bags used by an individual consumer according to the reduction in the number of used plastic shopping bags.

Since the CO₂ emission quantity can also be acquired from the consumer from the company side, the reduction goal is easily achieved, the CO₂ reduction quantity can be numerically expressed, and a transaction with an individual consumer is therefore possible.

### BEST MODE FOR CARRYING OUT THE INVENTION

Embodiments of the present invention will be described with reference to the drawings.

FIG. 1 is a schematic diagram showing an overview of an embodiment of the present invention.

In FIG. 1, the present invention has an administration server 1; a consumer terminal 2, a POS register 5, a recovery box apparatus 6, and a company terminal 7 of a company that provides a free gift, with the terminals, the register, and the apparatus being connectively configured via communication with the administration server 1; an eco card 3 retained by the consumer; and an eco bag 4 used by the consumer.

The consumer terminal 2 is configured so as to be capable of connecting to the administration server 1 via the Internet, a telephone line, or other communication. The consumer terminal 2 may be composed of a so-called personal computer, a mobile telephone terminal, or the like, for example.

A browser or other computer program is installed in the consumer terminal 2, and the consumer terminal 2 is capable of acquiring and outputting home page data transmitted by the administration server 1, and transmitting predetermined data to the administration server 1.

The consumer terminal 2 is provided with a barcode reader, and may have a program installed therein for performing processing described hereinafter for reading and decrypting a two-dimensional barcode recorded on a receipt and accessing a URL or the like included in the two-dimensional barcode.

The eco card 3 is a card retained by a consumer who is registered as an eco member. The eco card 3 may be composed of a magnetic card, an IC card, an optically readable card, or the like.

At least an eco member ID for identifying a consumer who is a member is stored in the eco card 3.

The eco card 3 may also be configured so as to store a name or other personal information of the consumer, and a store ID for identifying a store to which the consumer belongs as a member.

The eco bag 4 is a bag used by the consumer instead of a plastic shopping bag.

In the present example, the eco bag 4 is rented (including free rental) by a store to the consumer.

An IC tag 41 is attached to the eco bag 4. The IC tag 41 has memory, a CPU, and a transceiver apparatus, and a tag ID for identifying the IC tag is stored in the memory. Besides the tag ID, size information of the eco bag 4 to which the tag is attached is also stored in the memory of the IC tag 41. The size of the eco bag 4 is information indicated as LL, L, M, S, and other sizes suitable for the eco bag 4.

The ID and size information stored in the memory are thereby transmitted to an IC tag reader in response to excitation by readout radio waves from the IC tag reader.

The POS register 5 is a terminal placed in a supermarket, convenience store, or other store. Inputting the information of a product purchased by the consumer enables the POS register terminal to collect information of the purchased product.

An IC tag reader 51 for reading the IC tag 41, and a card reader (not shown) for reading the eco card 3 are connected or provided to the POS register 5. Radio waves for reading the IC tag are thereby emitted from the IC tag reader 51, and the tag ID or size information of the IC tag 41 can be acquired through the response signal from the IC tag 41.

The recovery box 6 is a box for recovering an eco bag that is no longer being used by a consumer.

The recovery box 6 has a communication apparatus, and is capable of transmitting and receiving data with respect to the administration server 1.

The recovery box 6 has an insertion hole 61 for an eco bag 4 formed at the top end, an IC tag reader (not shown) provided to the insertion hole 61, a display 62 for displaying data and the like received from the administration server 1, and a printer 63 for printing a free gift application form. An application form for a free gift can be printed by the printer 63.

The company terminal 7 is a terminal possessed by a company that purchases a CO₂ emission quantity from a consumer by providing a free gift.

The company terminal 7 is configured so as to be capable of connecting to the Internet and receiving and transmitting data through the use of a browser program.

The administration server 1 is a computer for performing processing and the like to calculate the quantity of plastic shopping bags reduced by the consumer, and the corresponding CO₂ emission quantity.

The administration server 1 may be composed of the functional blocks shown in FIG. 2 through the use of a CPU (Central Processing Unit), RAM (Random Access Memory), ROM (Read-Only Memory), or other memory; a hard disk drive or other external memory; and a computer program executed by the CPU.

The functional blocks shown in FIG. 2 are a consumer database (DB) 101, a store database (DB) 102, a free gift database (DB) 103, a company database (DB) 104, an emission quantity database (DB) 105, a communication/authentication processing section 106, a registration processing section 107, a points processing section 108, and a free gift processing section 109.

The consumer database 101 is a database for the eco ID, the tag ID, size information indicating the size of the eco bag used by the consumer, the name and other personal information of the consumer, information of a free gift desired by the consumer, preferred product information, purchase history information, monthly usage spending, and other information.

The information of a free gift desired by the consumer is information of a free gift for which the consumer desires to exchange accumulated points. This free gift information can be modified and registered at any time by the consumer.

The preferred product information is information of products preferred by the consumer, is registered by the consumer when the consumer registers as an eco member, and includes, for example, information of a product (DVD, mobile telephone set, television, or the like) that is currently wanted by the consumer.

The purchase history includes information of when, at which store (store ID), what product (product ID), what price (price information), and other information relating to the consumer.

The monthly usage spending is an average amount of money representing the amount of monthly consumption by the consumer. The purchase history, monthly usage spending, and other data may be stored as needed.

The store database 102 is a database of the store ID, store name, stocking information, and other store information.

The free gift database 103 is a database of information of free products provided by a company. The free gift database 103 is capable of storing a free gift ID, a free gift name, a free gift model number, a free gift photo image, a providing company ID, a necessary point number and CO₂ emission quantity to exchange for the free gift, and a negotiation condition.

The necessary point number and CO₂ emission quantity to exchange for the free gift are the point number and CO₂ emission quantity that the consumer must have in order to exchange for the free gift, and can be arbitrarily determined and registered by the company providing the free gift.

The negotiation condition is a condition for free gift exchange that is proposed from the company when the consumer performs a comparison with a free gift provided by another company. A negotiation rate, as well as company information of the company to be negotiated with, may be stored as the negotiation condition. For example, when both manufacturer A and manufacturer B manufacture a DVD player, manufacturer A may register a negotiation condition in the form of a 10% negotiation rate, with manufacturer B as the company information, in order to compete with the product of manufacturer B.

A condition can thereby be presented in which the free gift DVD player provided by manufacturer A is provided to the consumer for a 10% discounted rate of 270 points instead of the original 300 points when the consumer is confronted with a competing DVD player provided by manufacturer B.

A CO₂ emission quantity possessed by the consumer may also be set in a condition as one of the negotiation conditions. For example, the possession of a CO₂ emission quantity of 500 g or greater by the consumer may be registered as a condition for lowering an originally 1000-point DVD player to 900 points through negotiation. This means that because eco points added to the normal eco points (number of plastic shopping bags reduced, i.e., points according to a CO₂ emission amount) are awarded at such times as when the eco bag is returned to the store early, it is not necessarily the case that the eco points be equal to the CO₂ emission quantity, and a CO₂ emission quantity held by the consumer can therefore be made into a condition in order for a company to obtain a necessary CO₂ emission quantity.

The company is free to choose whether to set the negotiation condition.

The company database 104 is a database of information relating to a company.

A company ID, a company name, a CO₂ reduction quantity acquired by a company, and a CO₂ reduction goal can be stored in the company database 104.

The emission quantity database 105 is a database of eco points and CO₂ reduction quantities acquired by the consumer.

An eco ID for specifying a consumer, a CO₂ reduction quantity reduced by the consumer through the use of an eco bag instead of a plastic shopping bag, acquired eco points, tentative eco points, and the acquisition date of tentative eco points can be stored in the emission quantity database 105.

An eco point is a point awarded according to the CO₂ reduction quantity. The eco points are awarded according to the size of the eco bag, so that 3 points for one LL size bag, 2 points for one L size bag, 1 point for one M size bag, 0.5 points for one S size bag, or the like are awarded, for example. The number of eco points is verified in advance.

The CO₂ reduction quantity and the eco points are related to each other in such a way that the CO₂ reduction quantity indicates a numeric value that is in accordance with the number of plastic shopping bags not used as a result of the consumer using the eco bag instead of plastic shopping bags. For example, an actual CO₂ reduction quantity of 0.5 g or the like is represented by an L size plastic shopping bag. However, the eco points basically correspond to the CO₂ emission quantity so that one point equals 1 g, but eco points are sometimes added when the consumer returns the bag early, or at other times, and in this case, the number of points no longer equals the CO₂ emission quantity.

The tentative points are points awarded when the consumer purchases a product. The tentative points are verified as formal eco points the next time the consumer uses the eco bag 4, or when the eco bag 4 is recovered in the recovery box 6.

The communication/authentication processing section 106 performs transmission and reception processing of data with the consumer terminal 2, the POS register 5, the recovery box 6, the company terminal 7, and other components.

The communication/authentication processing section 106 also performs authentication processing of the eco ID or tag ID transmitted from the consumer.

The registration processing section 107 performs processing for registering data inputted from the consumer terminal 2, the POS register 5, the recovery box 6, and the company terminal 7 in the databases.

The registration processing section 107 also performs processing for correlating the tag ID of the eco bag with the card ID of the eco card 3 of the consumer and registering the tag ID and card ID in the consumer database 101.

The points processing section 108 performs processing for issuing tentative points, point conversion processing for converting tentative points into formal eco points, point counting processing, and the like.

The point conversion processing is processing for rewriting points stored as tentative points into formal eco points. The points processing section 108 at this time can perform processing for computing the elapsed time from issuance of the tentative points, or the elapsed time from the start of eco bag rental to return thereof, and applying a predetermined ratio to the tentative points according to the elapsed time to generate eco points.

The free gift processing section 109 performs processing for exchanging eco points for a free gift.

When a negotiation condition is set for a free gift being provided by a company, the free gift processing section 109 performs processing for computing a condition (number of eco points that can be exchanged for the free gift) that is in accordance with the negotiation condition, and transmitting the condition to the consumer terminal.

The free gift processing section 109 also performs processing for granting a CO₂ emission quantity in accordance with acquired eco points to the company providing the free gift. This processing calculates 1 eco point as 10 g of CO₂ reduction in a case in which 10 g of CO₂ are reduced per 1 eco point.

The overall flow of a transaction will next be summarized with reference to FIG. 1.

The consumer, store, and company information; negotiation conditions set by companies; and other information is registered in advance in the various databases.

First, the consumer brings his own eco card 3 and rents the eco bag 4, and uses the eco bag 4 for shopping (1). Rental of the eco bag 4 may be with or without charge.

At the time of product liquidation, the consumer presents the eco bag 4 at the POS register, whereupon the tag ID and size information of the IC tag 41 of the eco bag 4 are read by the IC tag reader 51, whereby the administration server 1 counts a use of the eco bag and issues tentative points based on the size to the consumer. The administration server 1 converts the tentative points issued in the previous shopping visit into formal eco points (2).

Eco points accrue to the consumer in sequence through repetition of the process described above.

When the consumer returns the eco bag 4 to the recovery box 6, the recovery box 6 reads the tag ID of the IC tag of the returned eco bag and transmits the tag ID to the administration server 1, whereby the administration server 1 verifies the tentative points issued to the consumer and tabulates the eco points (3).

The consumer views the tabulated eco points, and selects and requests a free gift from the administration server 1 by accessing a web page for point administration from the consumer terminal 2 (4).

The administration server 1 is notified of a free gift exchange request with respect to the company terminal 7 according to the eco points (which correspond to a CO₂ reduction quantity) from the consumer (5).

When the consumer exchanges eco points for a free gift provided by the company, a CO₂ emission quantity in accordance with the number of eco points is issued to the company providing the free gift (e.g., 1 g per 1 point, or the like), and the sequence of processing is ended.

The consumer thereby acquires eco points (points corresponding to a CO₂ emission quantity) according to the size and number of uses of the eco bag the consumer uses, i.e., according to the number of plastic shopping bags not used, and can receive a free gift by accumulating the eco points.

The company can acquire CO₂ emission quantities accumulated by the reduction of plastic shopping bags by the consumer by exchanging free gifts for CO₂ emission quantities.

The processing performed when the consumer initiates rental of an eco bag at the POS register 5 among the routines described above will next be described with reference to FIG. 8.

In FIG. 8, the register clerk presses the eco bag registration button of the POS register 5 in response to a request from the consumer to rent an eco bag (S101).

The POS register 5 reads the card ID (eco ID) of the eco card inserted into an eco card reader not shown in the drawing (S102).

The POS register 5 also reads the tag ID and tag size data of the eco bag through the use of the tag reader 51 (S103).

The POS register 5 then transmits the read eco ID and tag ID to the administration server 1 via communication (S104).

The registration processing section 107 of the administration server 1 correlates the transmitted eco card ID, tag ID, and size information and registers the correlated information in the consumer database 101 (S105).

When an eco ID is already registered, a tag ID is registered in correlation with the registered eco ID.

Tentative points and eco points can thereby be granted according to the usage of each eco bag even when one consumer uses multiple eco bags 4.

The processing performed when points are granted during a sale at the POS register will next be described with reference to FIG. 9.

In FIG. 9, the IC tag reader 51 of the POS register 5 reads the tag ID and size information from the IC tag 41 of the eco bag 4 brought by the consumer (S201).

The POS register 5 also acquires the product purchase information of the consumer (S202). The product purchase information can be acquired by reading a barcode on the product, or by manual input by the clerk, for example.

The POS register 5 then transmits the acquired tag ID and product purchase information to the administration server 1 (S203).

The communication/authentication processing section 106 of the administration server 1 registers the received product purchase information as a purchase history in the consumer database 101, and the points processing section 108 generates tentative points from the received size information and re-use period of the bag (S204).

The tentative points can be generated by granting base points in accordance with the size of the eco bag; e.g., 3 points for LL size, 2 points for L size, 1 point for M size, and 0.5 point for S size.

Tentative points=Base points according to size

In another example, points may be calculated according to a point increase rate in accordance with the length of time until re-use of the eco bag 4.

Tentative points=Base points according to size×Increase rate according to time until re-use

In this arrangement, the increase rate according to the time until re-use may be determined according to a table of predetermined variation rates in accordance with the time until re-use of the eco bag, for example, in which the increase rate is 60% for the 0^{th} to 3^{rd} days, 50% for the 4^{th} to 7^{th} days, 40% for the 8^{th} to 9^{th} days, 20% for the 10^{th} to 14^{th} days, 10% for the 15^{th} to 16^{th} days, and 0% (no adjustment) for the 17^{th} day and later, or the like, and the points are increased or decreased in accordance with the time until re-use.

The consumer can thereby be prevented from not returning the eco bag 4, use within a rapid cycle can be encouraged, and virtual personalization of the rental eco bag (use as the consumer's own eco bag) can be achieved.

The points processing section 108 also references the consumer database 101 from the received tag ID and specifies an eco member ID (S105), and stores tentative points and the acquisition date in correlation with the specified eco member IC in the emission quantity database 105 (S106).

The points processing section 108 references the emission quantity database 105 and determines whether there are tentative points from a previous time of purchasing (S207).

When the results of the determination indicate that there were tentative points granted at the time of a previous purchase, the points are converted to eco points without modification (S208). In other words, 10 tentative points are converted to 10 eco points, for example.

When a determination is made by the processing of S207 that there are no tentative points, or when the processing of S208 is completed, the points processing section 108 adds the converted eco points to eco points that are already held, computes the current total eco points (S209), and transmits the tentative points from the current purchase, the special points from the previous purchase, and the current total eco points to the POS register 5 (S210).

The POS register 5 receives the transmitted tentative points from the current purchase, the special points from the previous purchase, and the current total eco points, and issues a receipt on which the points are printed (S211), and the processing is ended.

An example of the receipt in this case is shown in FIG. 10. As shown in FIG. 10, the current product purchase information 502 of the consumer, as well as the tentative points of the current visit, the eco points of the previous purchase, and the current total points 503 are printed on the shopping receipt 501.

The address 504 of a point confirmation site where the consumer confirms the current points using the consumer terminal 2, and a two-dimensional barcode 505 having the point confirmation site in the form of a two-dimensional barcode are also printed. The consumer can view the current point total, the tentative points, and other information by accessing the address.

The eco bag return process will next be described with reference to FIG. 11.

In FIG. 11, when the eco bag 4 being rented by the consumer is placed in the insertion hole 61 of the recovery box 6, the IC tag reader reads the IC tag 41 of the returned eco bag 4 to acquire the tag ID, which is transmitted to the administration server 1 (S301).

The communication/authentication processing section 106 of the administration server 1 thereby references the consumer database 101, specifies the eco ID from the tag ID (S302), and specifies the member personal information from the eco member ID.

The points processing section 108 references the emission quantity database 105 and determines whether there are tentative points from the time of a previous purchase (S304).

When the results of the determination indicated that there are tentative points, the points processing section 108 converts the tentative points of the previous purchase into formal eco points (S305).

At this time, the points processing section 108 may vary the eco points granted according to the period of time from the start of eco bag rental until return.

In this case, the variation rate may be determined in advance so as to be a 30% increase for the 0^{th} to 3^{rd} days, 25% for the 4^{th} to 7^{th} days, 20% for the 8^{th} to 9^{th} days, 10% for the 10^{th} to 14^{th} days, 5% for the 15^{th} to 16^{th} days, and 0% for the 17^{th} day and later between the start of rental and return, and the eco points granted may thereby be calculated.

Eco points=Tentative points×Variation rate

Accordingly, when the bag is returned on the same day, and there are 10 tentative points, a 30% increase is applied to give 13 points.

The eco points thereby increase the earlier the eco bag 4 is returned, and the rental eco bags can be rapidly recovered from the consumer.

The points processing section 108 computes the total eco points from adding the converted eco points to the already-held eco points (S306), and transmits the total eco points and the member personal information specified in S303 to the recovery box 6 (S307).

The recovery box 6 displays a free gift application form in which the total points and the member personal information are entered on the display 62, and prints the form from the printer 63 (S308), and the processing is thereby ended.

An example of the free gift application form is shown in FIG. 12. As shown in FIG. 12, the total eco points 602, the home page address 603 for free gift exchange, and a two-dimensional barcode 604 having the home page address for free gift exchange in the form of a two-dimensional barcode are printed on the free gift application form 601.

Application and point enquiry for free gift exchange can thereby be performed by accessing the free gift exchange home page.

The processing performed when the consumer exchanges accumulated eco points for a free gift will next be described with reference to FIG. 13.

In FIG. 13, the consumer inputs the address and eco ID shown in the printed free gift application form into the consumer terminal 2 and accesses the home page (S401).

The communication/authentication processing section 106 of the administration server 1 performs authentication processing of the received eco ID (S402), and transmits the data of the free gift application screen to the consumer terminal 2 (S403).

A screen showing the free gift application site is shown in FIG. 14.

As shown in FIG. 14, the current total eco points 702, a product 703 desired as the free gift, a manufacturer 704 indicating the company providing the free gift, a negotiation selection button 705 indicating selection of a free gift by negotiation, a free gift selection completion button 706 indicating completion of free gift selection, and a logout button 707 are displayed in the free gift application site 701.

The product button 703 and the manufacturer button 704 are pull-down buttons, and a free gift can be selected based on any of these buttons according to the product name or the manufacturer name.

The consumer terminal 2 determines whether the consumer has selected a negotiation displayed on the received free gift application screen (S404).

When a negotiation has been selected, the free gift processing section 109 of the administration server 1 executes the negotiation routine described hereinafter, and receives the selection of the desired free gift from the consumer (S405, 406).

When selection of the free gift is completed, the free gift processing section 109 stores the free gift selected by the consumer in the consumer information database 101 (S407) and transmits a free gift issuing instruction to the company terminal 7 (S408). A product that is the free gift is thereby delivered to the consumer directly from the free-gift providing company, or via the store.

The free gift processing section 109 transfers a CO₂ reduction quantity that is in accordance with the number of reduced plastic shopping bags possessed by the consumer to the company ID with respect to the manufacturer providing the free gift, and stores the CO₂ reduction quantity in the company database 104 and the emission quantity database 105 (S409), and processing is ended.

The detailed process involved in the negotiation processing will next be described with reference to FIG. 15.

In FIG. 15, the negotiation selection button 705 is pressed by the consumer, whereby the free gift processing section 109 receives a negotiation selection button pressing instruction (S451), references the free gift database 103, retrieves a company that provides the same product as the currently selected product, and displays the retrieved company (S452, S453).

An example of this process is shown in FIG. 16. The list screen as shown in FIG. 16 displays the company name 710 providing the DVD desired by the consumer as a free gift, the product name 711, the eco point number 712 necessary for free gift exchange, a selection button 713 for selecting a company (free gift) from a list, a negotiation request button 714, and a cancel button 715.

The consumer checks the selection button 713 for the company to be negotiated with from the displayed list of companies, and presses the negotiation request button 714, and the free gift processing section 109 thereby receives selection of the company to be negotiated with (S454).

The free gift processing section 109 references the free gift database 103 and determines whether the providing company has set a negotiation condition for the selected product (S455).

When the results of the determination indicate that the product does not have a negotiation condition set, the product is not considered to be the subject of negotiation, and the negotiation processing is ended.

When a determination is made that a negotiation condition has been set, the free gift processing section 109 reduces the eco points necessary for free gift exchange in accordance with the negotiation condition set by the company, and displays the eco points (S456).

For example, in the example shown in FIG. 16, when Yamashita Denki Sangyo is in competition with another company for the DVD player, what was normally “200 points” is displayed as the 10% reduced “180 points” when a negotiation condition of a 10% reduction has been set. In the same manner, when Jeep Co. has set “Yamashita Denki Sangyo” as the negotiation subject, and 10% as the negotiation rate, since Yamashita Denki Sangyo is present in the list, what was normally “180 points” is displayed as the 10% negotiation rate-reduced “162 points.”

The free gift processing section 109 determines whether negotiation was selected again in this state (S457).

When negotiation was selected again, the process returns to S453, and processing is repeated.

In this case, the named company determines the lowest negotiation condition, and when negotiation goes below the lowest condition, the previous necessary points are displayed without modification by negotiation processing.

When any of the free gifts is selected and renegotiation was not selected, the free gift processing section 109 receives the information of the selected company and free gift (S458), and the process then proceeds to S407 described above.

By thus performing negotiation processing, the consumer can acquire a free gift under more advantageous conditions.

The company also registers negotiation conditions in advance, and can thereby provide a free gift to the consumer under more advantageous conditions than a rival company, and can promote the company's own product.

In the above example, a case was described in which a free gift is requested from a company by the consumer, but an example of a case in which a request (offer) to provide a free gift to a consumer is made from a company will next be described with reference to FIG. 17.

In FIG. 17, the free gift processing section 109 of the administration server 1 receives offers from companies to provide a free gift to the consumer, and stores the offers in the emission quantity database 105 in correlation with each eco ID (S501).

In this state, the consumer inputs or otherwise transmits an eco ID to the consumer terminal 2 and accesses the consumer terminal 2 (S502).

The communication/authentication processing section 106 thereby performs authentication of the eco ID (S503), the emission quantity database 105 is referenced, the offer information stored in correlation with the eco ID is acquired, and the offer details are transmitted to and displayed on the consumer terminal 2 (S504).

Displayed on the screen 800 in this case as shown in FIG. 18 are the current points and CO₂ reduction quantity 801, the providing company name 802 requesting (offering) to provide to the consumer, a product name 803 provided by the company to the consumer, a selection button 804, a completion button 805, and a cancel button 806.

The product name 803 is a pull-down button, and products provided by the company to the consumer can be selected from a pull-down menu.

In accordance with the screen display, the company and the product name provided by the company as a free gift are selected, and an instruction to press the completion button 805 is issued (S505), and the free gift processing section 109 registers the selected free gift information in the consumer database 101 (S506), and issues an instruction to the selected company to issue the free gift (S507).

The free gift processing section 109 references the emission quantity database 105, subtracts the CO₂ and corresponding eco points of the consumer who selected the free gift, references the company information database 104, and adds the CO₂ emission quantity possessed by the consumer to the CO₂ emission quantity of the free-gift providing company (S508), and the processing is ended.

The CO₂ emission quantity possessed by the consumer can thereby be transferred to the company in the form of a free gift exchange.

An example of more detailed processing involved in a case in which an offer is made from the company to the consumer in S501 will next be described with reference to FIG. 19.

In FIG. 19, the free gift processing section 109 acquires from each company a CO₂ reduction goal value that is the goal of each company (S601).

The free gift processing section 109 references the consumer information database 101 and searches for a consumer whose preference matches a free gift provided by a company (S602).

In this arrangement, a consumer whose preference is registered as a DVD player is searched for when a company is providing a DVD player as the free gift.

The free gift processing section 109 sorts consumers having matching preferences in the order of the highest number of retained points, and sequentially adds the CO₂ reduction quantities in the order of the largest retained CO₂ reduction quantity until the goal value of a company is reached (S603).

In the case of a company having a goal value of 1000 g, for example, when consumer A having a matching preference is 500 g, consumer B is 200 g, consumer C is 200 g, consumer D is 100 g, consumer E is 50 g, and consumer F is 30 g, consumers A through E are sorted in order and sequentially added, and since the goal value is reached by consumers A through D, consumers A through D become offer subjects, and the remaining consumers E and F are not eligible for the offer.

The free gift processing section 109 stores as offer subjects the information of the consumers selected as offer subjects in the emission quantity database 105 (S604), and processing is ended.

The specific processing of providing offer details from the company of S504 described above will next be described with reference to FIG. 20.

In FIG. 20, the free gift processing section 109 references the emission quantity database 105 and specifies a company that is offering to provide a free gift to the consumer (S611).

The free gift processing section 109 references the free gift database 103 to determine whether there is a free gift that can be provided for the acquired eco points of the consumer from among the offering companies (S612).

When the results of the determination are that there is no provided free gift, the processing is ended.

When the results of the determination are that there is a free gift that can be provided, a determination is made as to whether the consumer has a CO₂ reduction quantity equal to or greater than the CO₂ emission quantity that enables exchange of the provided free gift (S613).

When the results of the determination are that the consumer has the CO₂ emission quantity that enables exchange, the processing is ended.

When the results of the determination are that the CO₂ emission quantity is satisfied, a list of free gifts that can be provided is created for each company (S614), the list of free gifts that can be provided by each company is transmitted to the consumer terminal 2 (S615), and the processing following S505 previously described is performed.

A company can thus acquire the desired CO₂ emission quantity by making an offer. In other words, the size of the CO₂ emission quantity that can be acquired can be made to conform to a goal according to a selected consumer, a selected offer made to a consumer, and whether the offer is acknowledged.

### BRIEF DESCRIPTION OF THE DRAWINGS

FIG. 1 is a schematic diagram showing the overall structure of the system in an embodiment of the present invention;

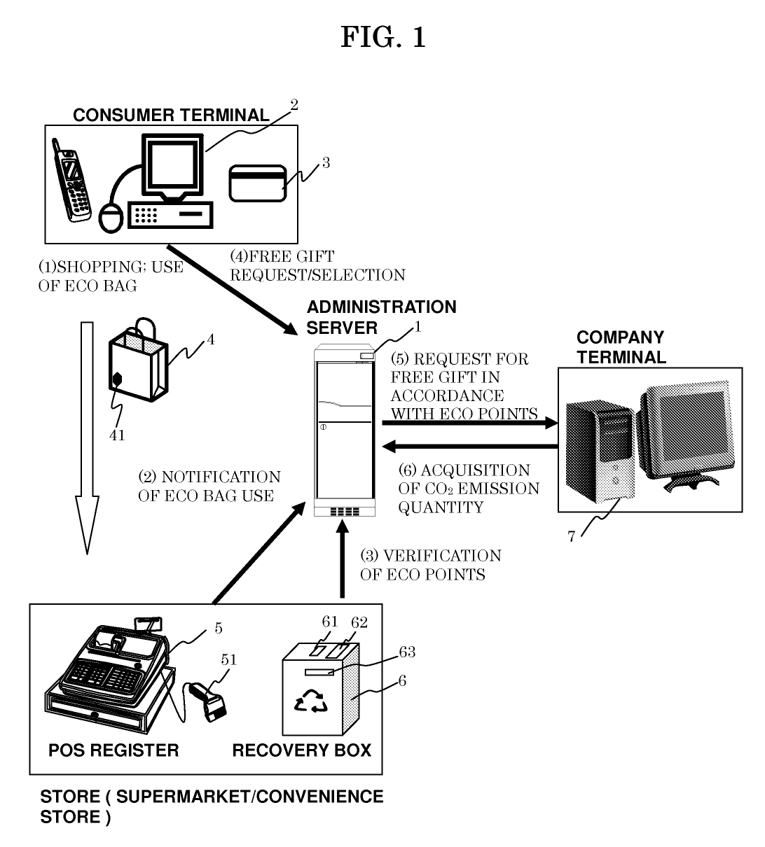

FIG. 2 is a functional block diagram of the administration server of the present embodiment;

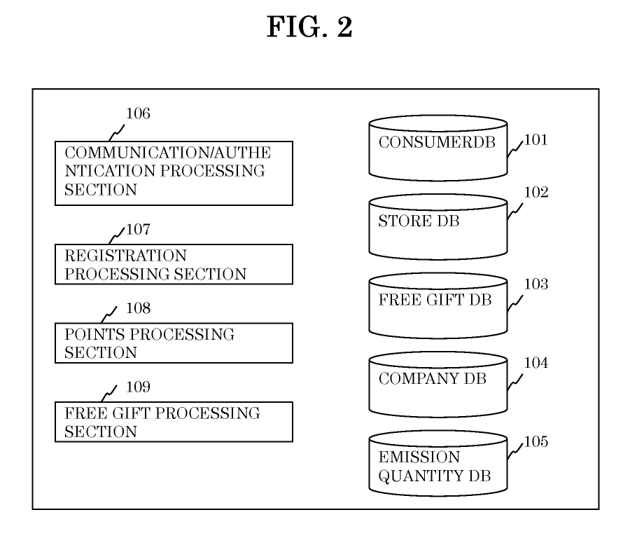

FIG. 3 is a diagram showing the data structure of the consumer database of the present embodiment;

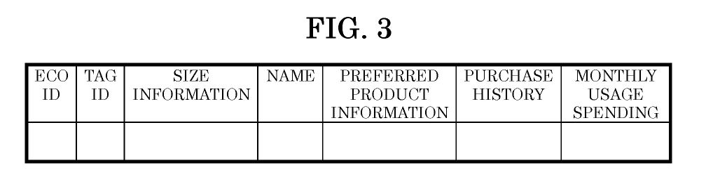

FIG. 4 is a diagram showing the data structure of the store database of the present embodiment;

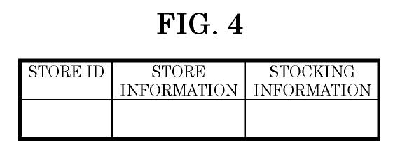

FIG. 5 is a diagram showing the data structure of the free gift database of the present embodiment;

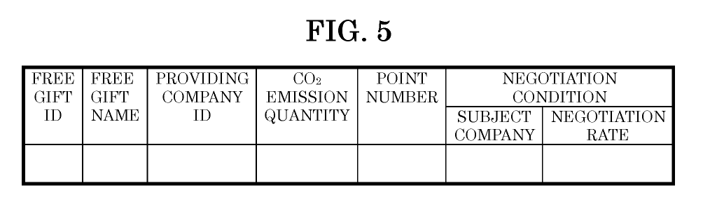

FIG. 6 is a diagram showing the data structure of the company database of the present embodiment;

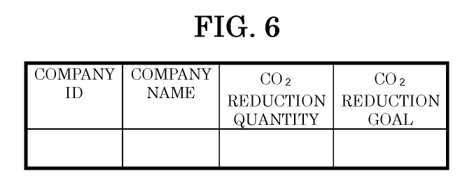

FIG. 7 is a diagram showing the data structure of the emission quantity database of the present embodiment;

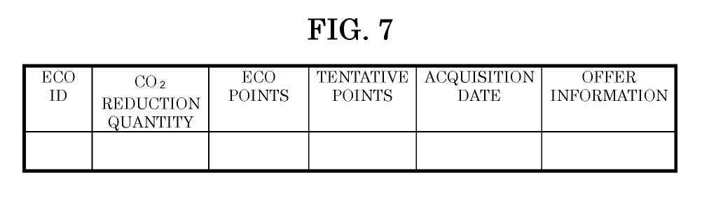

FIG. 8 is a diagram showing the flow of eco bag rental processing according to the present embodiment;

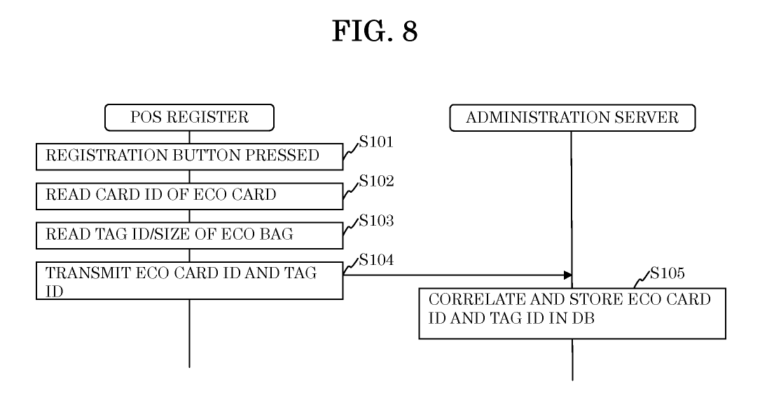

FIG. 9 is a diagram showing the flow of processing for issuing points at the time of a product sale according to the present embodiment;

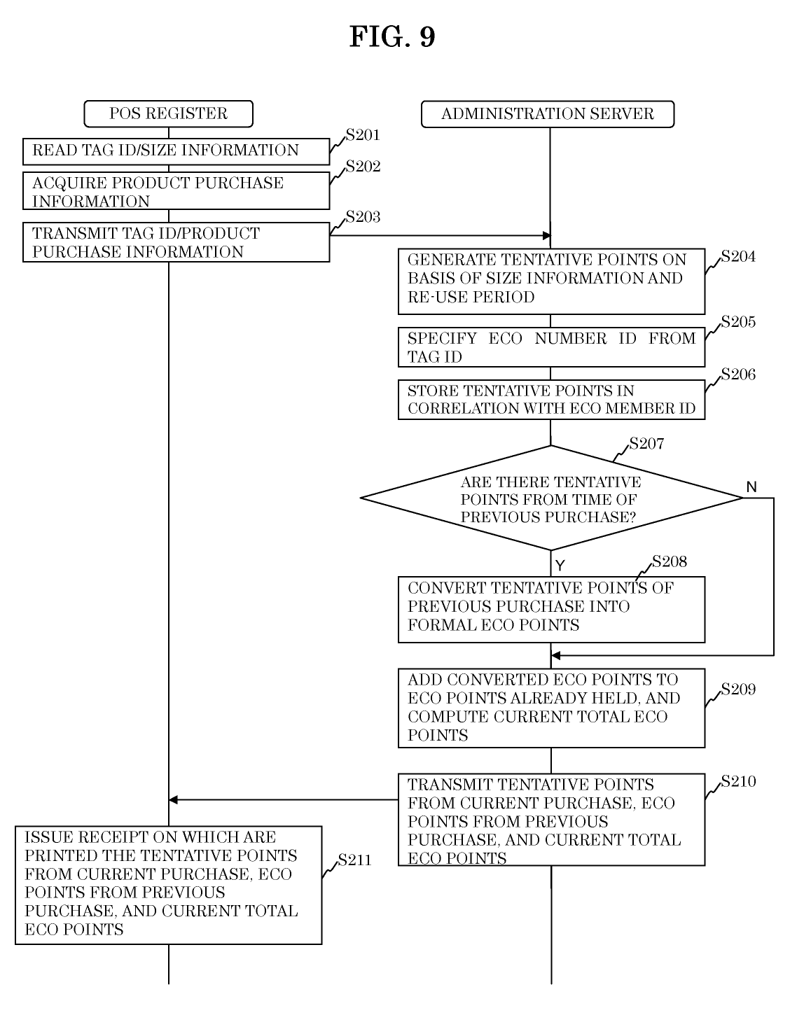

FIG. 10 is a diagram showing an example of the receipt according to the present embodiment;

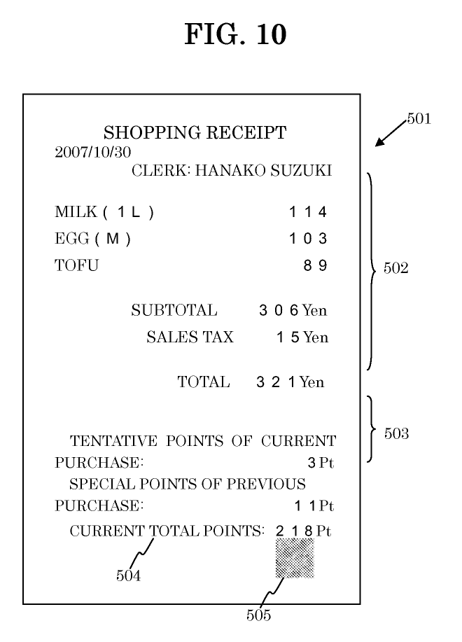

FIG. 11 is a diagram showing the flow of processing at the time of eco bag return according to the present embodiment;

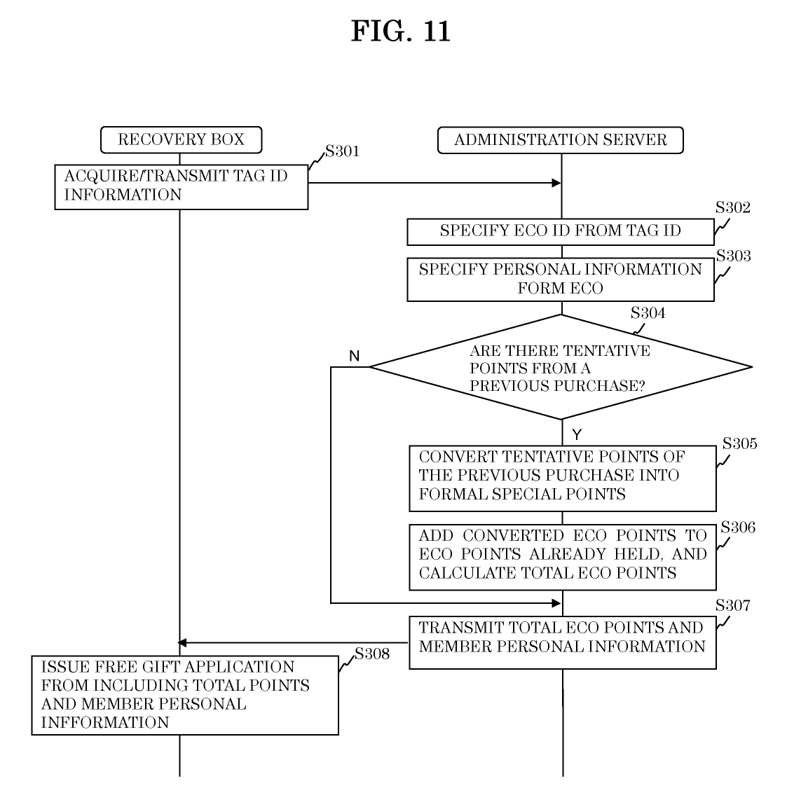

FIG. 12 is a diagram showing an example of the free gift application form according to the present embodiment;

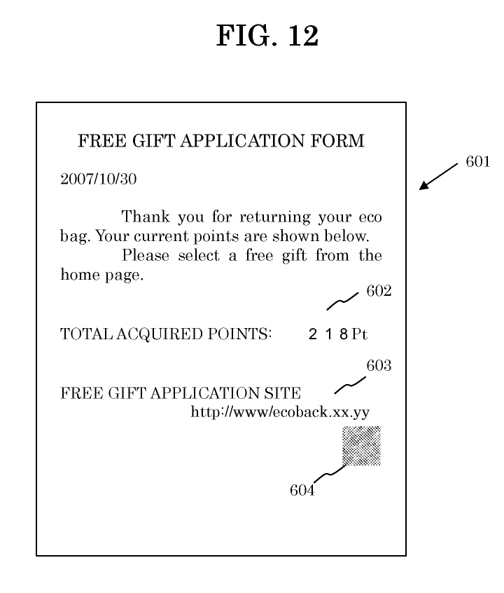

FIG. 13 is a diagram showing the flow of free gift selection processing according to the present embodiment;

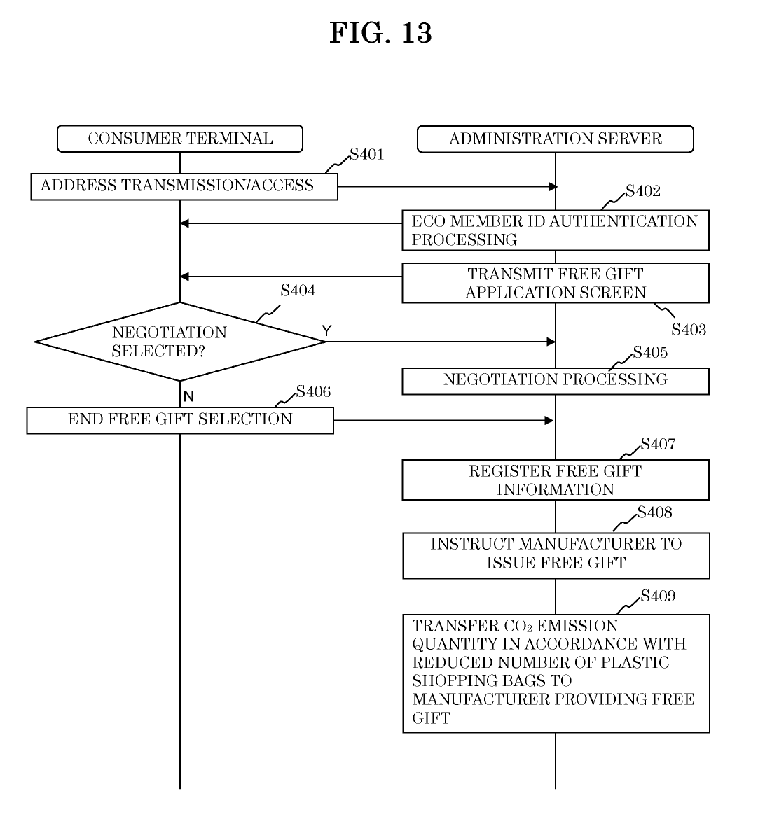

FIG. 14 is a diagram showing an example of the screen displayed on the free gift application site of the present embodiment;

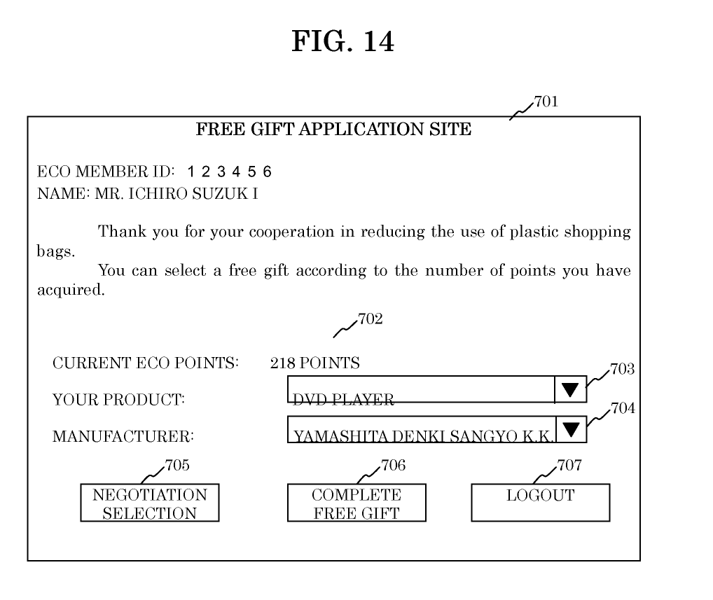

FIG. 15 is a diagram showing the flow of negotiation processing according to the present embodiment;

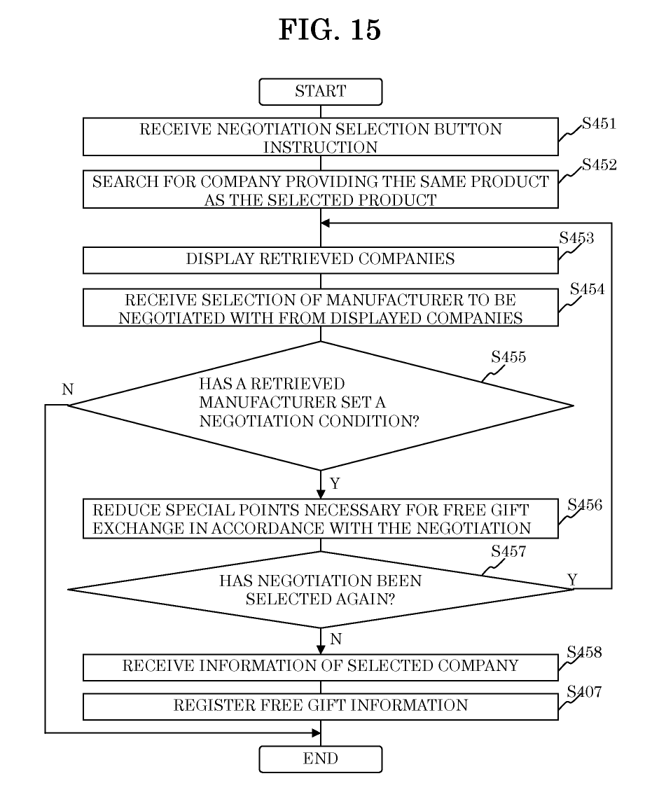

FIG. 16 is a diagram showing an example of the negotiation selection screen according to the present embodiment;

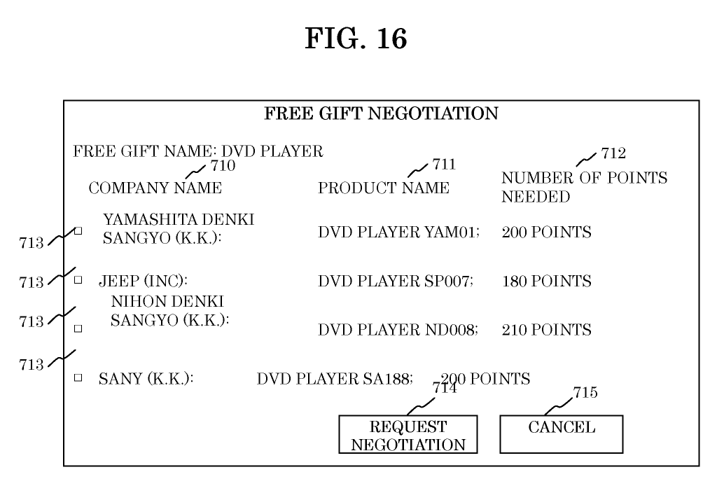

FIG. 17 is a diagram showing the flow of processing in the case of an inquiry from a company according to another embodiment;

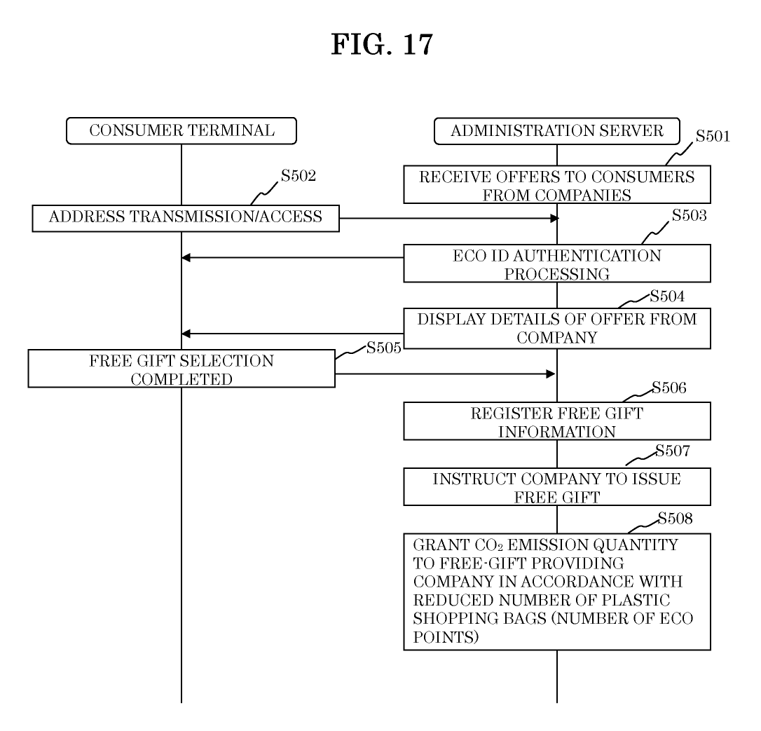

FIG. 18 is a diagram showing an example of the free gift offer screen of another embodiment;

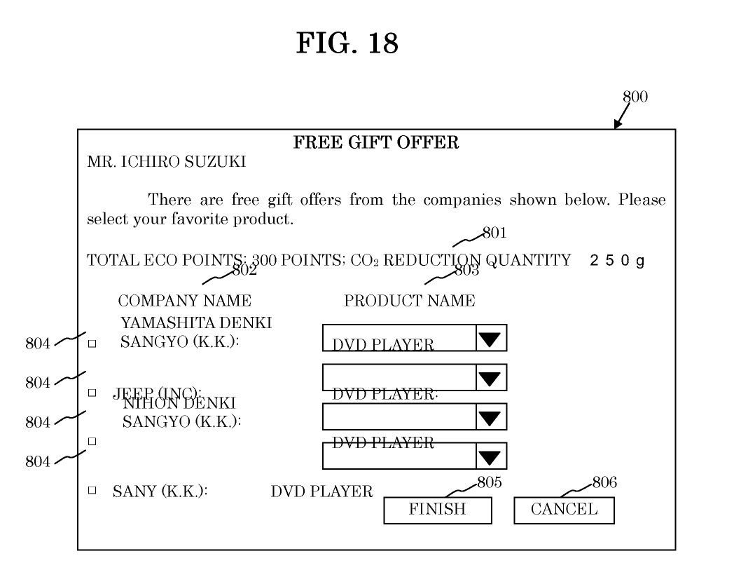

FIG. 19 is a flow diagram showing the detailed process of the free gift offer processing of another embodiment; and

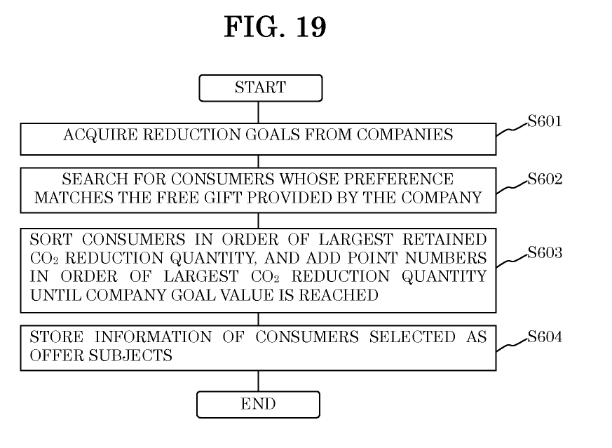

FIG. 20 is a flow diagram showing the specific processing for creating a free gift list for each consumer according to another embodiment.

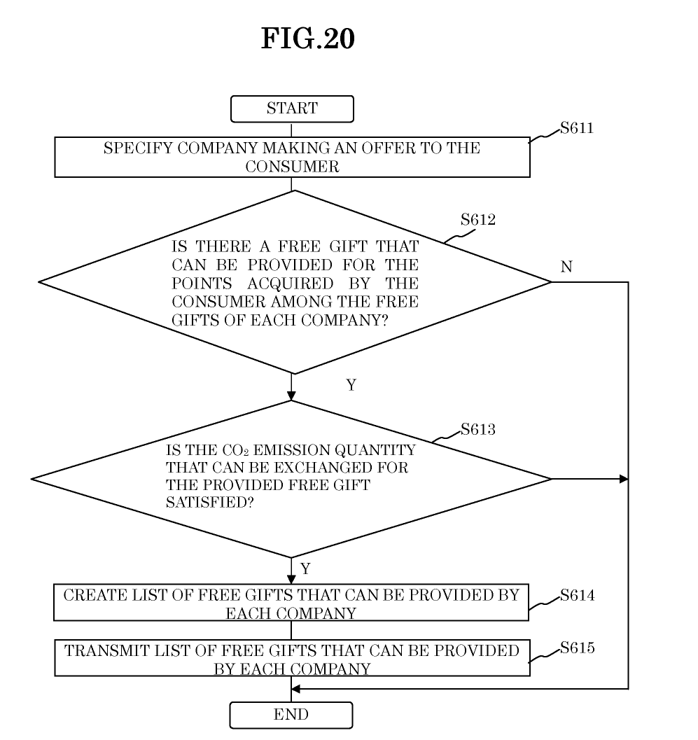

### Explanation of the Symbols

1 administration server
2 consumer terminal
3 eco card
4 eco bag
41 IC tag
5 POS register
51 IC reader
6 recovery box
61 insertion hole
62 display
63 printer
7 company terminal
101 consumer database
102 store database
103 free gift database
104 company database
105 emission quantity database
106 communication/authentication processing section
107 registration processing section
108 points processing section
109 free gift processing section

1. An apparatus configured so as to be capable of communicating with a consumer terminal used by a consumer, a company terminal used by a company, and a POS register terminal for reading size information capable of specifying a size of an eco bag and identification information of an eco bag possessed by the consumer when the consumer purchases a product, in order for the consumer to perform a transaction based on a personal CO₂ emission quantity, by converting to a CO₂ emission quantity a reduction number by which the used number of plastic shopping bags that are newly distributed each time the consumer purchases a product at a store is reduced by the use of an eco bag capable of being repeatedly used by the consumer when a product is purchased; the information processing apparatus characterized in comprising:
a consumer information storage device for storing consumer identification information for identifying the consumer in correlation with eco bag identification information that identifies the eco bag possessed by the consumer;
an emission credit storage device for storing, in correlation with the consumer identification information, points having a value corresponding to the CO₂ emission quantity and being acquired by the consumer through the use of the eco bag;
a company information storage device for storing, in correlation with the CO₂ emission quantity acquired by the company, company identification information for identifying a company that desires to acquire a CO₂ emission quantity;
a free gift information storage device for storing, in correlation with the company identification information, free gift information provided to the consumer by the company;
a base points storage device for storing, in correlation with size information of the eco bag, a point number having a value that corresponds to a CO₂ emission quantity commensurate with a number of plastic shopping bags not used due to using the eco bag;
a receiving device for receiving the size information and eco bag identification information read by the POS register terminal;
a points processing device for referencing the consumer identification information device, searching and specifying the consumer identification information correlated with the received eco bag identification information, referencing the base points storage device to generate points on the basis of a point number correlated with the received size information, and storing the generated points in the emission credit storage device in correlation with the consumer identification information; and
a free gift processing device for receiving, according to a request from the consumer terminal, a selection request of a free gift stored in the free gift information storage device in accordance with the point number acquired by the consumer that is stored in the emission credit storage device, issuing an instruction to the company terminal to provide the free gift to the consumer in accordance with the received free gift selection request, and storing the points used in the free gift exchange as a CO₂ emission quantity in the company information storage device in correlation with the company that provided the free gift.

2. The information processing apparatus according to claim 1, wherein:
an IC tag having the eco bag identification information is attached to the eco bag; and
an RFID reader connected to the POS register terminal reads the eco bag identification information of the IC tag, whereby the receiving device acquires the eco bag identification information.

3. The information processing apparatus according to claim 1, wherein:
the free gift information storage device stores negotiation condition information that has information of a company to be negotiated with, and a discount rate for discounting points necessary for a free gift exchange when the company to be negotiated with is specified; and
the free gift processing device determines whether the company to be negotiated with exists on the basis of the negotiation condition information stored in the free gift information storage device when the consumer specifies application of a negotiation condition, and when the company to be negotiated with exists, the free gift processing device discounts the points necessary for point exchange of the free gift provided by the company and transmits the points to the consumer terminal, on the basis of the discount rate set by the negotiation condition with the consumer.

4. The information processing apparatus according to claim 1, wherein
a CO₂ reduction quantity acquired by the consumer through the use of the eco bag is furthermore stored in the emission credit storage device;
the company information storage device furthermore stores a CO₂ reduction quantity that is a goal of the company;
the consumer information storage device furthermore stores preference information that includes information of a free gift desired by the consumer;
the consumer information storage device is referenced and a search is conducted for a consumer for whom a free gift provided by the company is registered as the preference information; and
the points storage device is referenced, users among consumers for whom a free gift provided by the company is registered as the preference information are sorted in order of the largest acquired CO₂ reduction quantity with reference to the emission credit storage device, the CO₂ reduction quantities are totaled and computed in sequence until the total CO₂ reduction quantity reaches the CO₂ reduction quantity that is the goal of the company, and offer information of free gift exchange is transmitted to the consumer terminal in which the consumer for whom the CO₂ reduction quantities were totaled is a consumer who is the subject of an offer made by the company for free gift exchange.

5. The information processing apparatus according to claim 1, wherein
the points processing device references the base points storage device and generates tentative points on the basis of a point number correlated with the received size information, and converts the tentative points stored in the emission credit storage device into formal points that can be exchanged for a free gift when a transmission is received indicating a next time that the consumer uses the eco bag; and
the emission credit storage device furthermore stores the generated tentative points in correlation with the consumer identification information.

6. The information processing apparatus according to claim 5, wherein the points processing device computes a time elapsed until the next time the consumer uses the eco bag after the tentative points generation, and varies a conversion rate for converting to the formal points according to a length of the computed elapsed time.

7. The information processing apparatus according to claim 5, configured so as to be furthermore capable of connecting to a recovery box apparatus for recovering the eco bag and acquiring recovered eco bag identification information; wherein
the points processing device converts the tentative points stored in the emission credit storage device into formal points that can be exchanged for a free gift when an eco bag recovery notification is received from the recovery box apparatus.

8. The information processing apparatus according to claim 7, wherein the points processing device computes a time elapsed from a day the eco bag was first used from the register terminal to a time of recovery by the recovery box apparatus, and varies the conversion rate for converting the tentative points into formal points according to the computed elapsed time.

9. A method executed by a computer configured so as to be capable of communicating with a consumer terminal used by a consumer, a company terminal used by a company, and a POS register terminal for reading size information capable of specifying a size of an eco bag and identification information of an eco bag possessed by the consumer when the consumer purchases a product, in order for the consumer to perform a transaction based on a personal CO₂ emission quantity, by converting to a CO₂ emission quantity a reduction number by which the used number of plastic shopping bags that are newly distributed each time the consumer purchases a product at a store is reduced by the use of an eco bag capable of being repeatedly used by the consumer when a product is purchased; the information processing method characterized in the computer having:
a consumer information storage device for storing consumer identification information for identifying the consumer in correlation with eco bag identification information that identifies the eco bag possessed by the consumer;
an emission credit storage device for storing, in correlation with the consumer identification information, points having a value corresponding to the CO₂ emission quantity and being acquired by the consumer through the use of the eco bag;
a company information storage device for storing, in correlation with the CO₂ emission quantity acquired by the company, company identification information for identifying a company that desires to acquire a CO₂ emission quantity;
a free gift information storage device for storing, in correlation with the company identification information, free gift information provided to the consumer by the company; and
a base points storage device for storing, in correlation with size information of the eco bag, a point number having a value that corresponds to a CO₂ emission quantity commensurate with a number of plastic shopping bags not used due to using the eco bag; and
the computer executing the steps of:
receiving the size information and eco bag identification information read by the POS register terminal;
referencing the consumer identification information device, searching and specifying the consumer identification information correlated with the received eco bag identification information, referencing the base points storage device to generate points on the basis of a point number correlated with the received size information, and storing the generated points in the emission credit storage device in correlation with the consumer identification information; and
receiving, according to a request from the consumer terminal, a selection request of a free gift stored in the free gift information storage device in accordance with the point number acquired by the consumer that is stored in the emission credit storage device, issuing an instruction to the company terminal to provide the free gift to the consumer in accordance with the received free gift selection request, and storing the points used in the free gift exchange as a CO₂ emission quantity in the company information storage device in correlation with the company that provided the free gift.

10. A storage medium in which a computer program is stored for causing processing to be executed in a computer that is configured so as to be capable of communicating with a consumer terminal used by a consumer, a company terminal used by a company, and a POS register terminal for reading size information capable of specifying a size of an eco bag and identification information of an eco bag possessed by the consumer when the consumer purchases a product, in order for the consumer to perform a transaction based on a personal CO₂ emission quantity, by converting to a CO₂ emission quantity a reduction number by which the used number of plastic shopping bags that are newly distributed each time the consumer purchases a product at a store is reduced by the use of an eco bag capable of being repeatedly used by the consumer when a product is purchased, the computer having:
a consumer information storage device for storing consumer identification information for identifying the consumer in correlation with eco bag identification information that identifies the eco bag possessed by the consumer;
an emission credit storage device for storing, in correlation with the consumer identification information, points having a value corresponding to the CO₂ emission quantity and being acquired by the consumer through the use of the eco bag;
a company information storage device for storing, in correlation with the CO₂ emission quantity acquired by the company, company identification information for identifying a company that desires to acquire a CO₂ emission quantity;
a free gift information storage device for storing, in correlation with the company identification information, free gift information provided to the consumer by the company; and
a base points storage device for storing, in correlation with size information of the eco bag, a point number having a value that corresponds to a CO₂ emission quantity commensurate with a number of plastic shopping bags not used due to using the eco bag; and
the storage medium in which a computer program is stored causes the computer to execute the steps of:
receiving the size information and eco bag identification information read by the POS register terminal;
referencing the consumer identification information device, searching and specifying the consumer identification information correlated with the received eco bag identification information, referencing the base points storage device to generate points on the basis of a point number correlated with the received size information, and storing the generated points in the emission credit storage device in correlation with the consumer identification information; and
receiving, according to a request from the consumer terminal, a selection request of a free gift stored in the free gift information storage device in accordance with the point number acquired by the consumer that is stored in the emission credit storage device, issuing an instruction to the company terminal to provide the free gift to the consumer in accordance with the received free gift selection request, and storing the points used in the free gift exchange as a CO₂ emission quantity in the company information storage device in correlation with the company that provided the free gift.
